(19) United States
(12) Patent Application Publication
(10) Pub. No.: US 2017/0016333 A1
(43) Pub. Date: Jan. 19, 2017

(54) FLUX MEDIATED DEPOSITION OF METALLIC GLASS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/800,773

(22) Filed: Jul. 16, 2015

(51) Int. Cl. F01D 5/28; B23K 35/36; C23D 5/04

(52) U.S. Cl. CPC F01D 5/28; C23D 5/04; B23K 35/3605; B23K 35/3607; B23K 35/3602; B23K 35/361

(57) ABSTRACT

A method and resulting gas turbine engine component (40) having a protective layer of metallic glass (14) deposited over a superalloy substrate (12). A further layer of ceramic insulating material (42) may be deposited over the metallic glass. The metallic glass functions as a bond coat to provide thermal insulation and mechanical compliance. The metallic glass may be deposited onto the substrate by a flux mediated laser deposition process wherein powdered alloy material (18) is melted together with powdered flux material (20). The flux material can facilitate the glass forming process by adding to the solidification confusion effect and/or by providing an active cooling effect.

### FIELD OF THE INVENTION

This invention relates generally to the field of materials technology.

### BACKGROUND OF THE INVENTION

Gas turbine engines (“GTEs”) generate energy by combusting a fuel in a compressed gas at a high temperature, then harvesting energy from the gas while the gas expands through a turbine. These engines operate most effectively at very high temperatures. For instance, in one engine design, an increase of 56 degrees Celsius in a turbine's firing temperature can provide a corresponding increase of 8-13% in output and 2-4% of improvement in simple cycle efficiency. The problem with raising gas temperatures is that the gas turbine engine components can tolerate only so much heat, and gases are often heated to temperatures exceeding the melting point of common metal alloys.

Various thermal barrier coatings (“TBC”'s) have been developed to increase the heat resistance of GTE components, especially those components (or portions thereof) in the hot gas path of the GTE. Bond coats such as MCrAIY have been applied to alloy components, then optionally further coated with heat resistant ceramics. MCrAIY coatings are oxidation and corrosion resistant and extend the service life of gas turbine components. Another purpose of the bond coat is to aid in the bonding of the overlying ceramic to the substrate without cracking because the two materials have different coefficients of thermal expansion. Ceramics are widely used because of their ability to resist very high temperatures, but ceramics are not as durable as their alloy substrates.

While metallic glasses can exhibit high strength, high hardness and low thermal conductivity, the present inventors have found no commercially successful exploitation of such materials in the field of gas turbine engines. Metallic glasses are a group of metallic alloys that form an amorphous (non-crystalline) microstructure upon sufficiently rapid cooling from the molten state. They are generally manufactured by vacuum injection molding (VIM) or melt spinning in an inert gas because atmospheric impurities such as oxygen, nitrogen, hydrogen and carbon can initiate crystallization and result in inferior properties. Traditionally, metallic glasses could be produced in only thin layers because of the rapid cooling requirement (≈10⁶° K/s). More recently, multi-component metallic glasses have been produced with more modest cooling rates (≈1° K/s) and in much thicker sections. Such material has been termed bulk metallic glass (BMG), but they are still limited to thicknesses of only several centimeters, and no practical application of such materials for high temperature engine components is known to the present inventors.

Metallic glass in the form of powder has been used as a constituent for a coating applied to a turbomachine component. United States Patent Application Publication No. US 2014/0287149 A1 describes a substrate coated by applying at least two different base powders, wherein the at least two different base powders are selected from the group of metallic materials, ceramics, MAX phases (layered hexagonal carbide or nitride), metallic glasses, inorganic glasses, organic glasses, organic polymers or combinations thereof. Each powder of the coating is selected for a specific property that it imparts to the coating system. While such composite coatings may have useful application, they do not exhibit the full properties of a metallic glass material.

For economic, environmental, and overall performance considerations, there is an ongoing need for further improvements to GTE components to facilitate higher temperature engine operations.

### BRIEF DESCRIPTION OF THE DRAWINGS

The invention is explained in the following description in view of the drawings that show:

FIG. 1 illustrates a gas turbine engine component, in accordance with an embodiment.

FIG. 2 illustrates a process for flux mediated deposition of metallic glass on a crystalline alloy material, in accordance with an embodiment.

FIG. 3. Illustrates a cross-section of a melt pool having gas generating agents dispersed therein, in accordance with an embodiment.

FIG. 4 illustrates a component formed by a process for flux mediated deposition of metallic glass, in accordance with an embodiment.

### DETAILED DESCRIPTION OF THE INVENTION

The present inventors have developed methods for depositing a layer of metallic glass on a crystalline alloy substrate, thereby for the first time allowing the properties of bulk metallic glass to be exploited for use in high temperature combustion environments. Metallic glass must be cooled rapidly and shielded from impurities to achieve its amorphous structure, issues which the art has not addressed for gas turbine engine component manufacturing applications. As explained in more detail below, the present inventors have solved these issues with novel flux-mediated processes designed to protect the metallic glass from the atmosphere during cooling, to facilitate the formation of an amorphous structure during cooling, and/or to assist in heat removal during cooling. The resulting layer of metallic glass can be deposited in commercially meaningful thicknesses, and it can function to protect the underlying substrate in much the same way as a traditional thermal barrier and bond (MCrAIY) coating, but with higher strength and lower thermal conductivity.

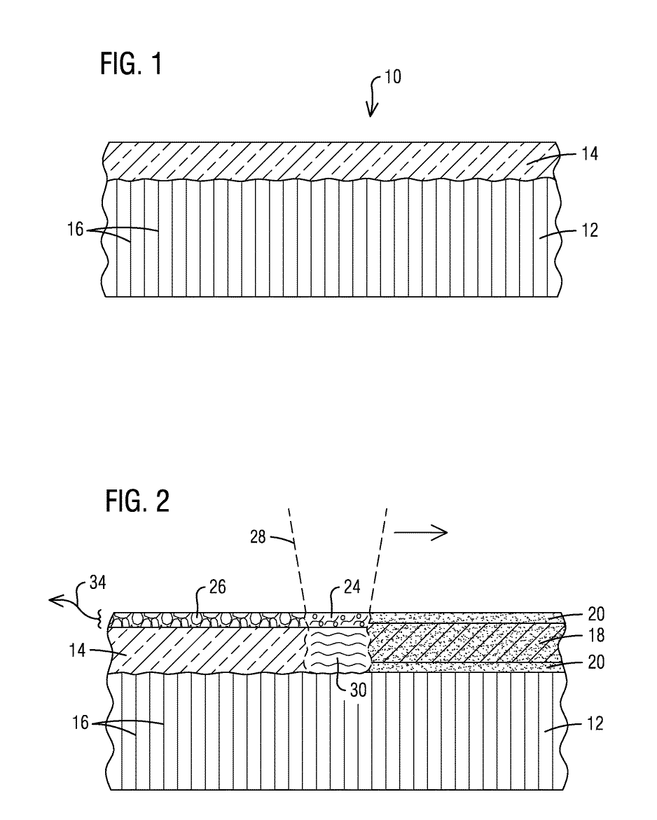

FIG. 1 shows an embodiment of a GTE component 10 including a substrate 12 having a layer of metallic glass 14 disposed on the substrate. The substrate may be a crystalline superalloy substrate, and may be a directionally solidified material having a plurality of columnar grains 16. The metallic glass may be any metallic glass having a glass transition temperature (T_{g}) above a predetermined threshold making it useful in the gas turbine environment. While the temperature within an operating gas turbine engine varies greatly along the gas flow path, the present inventors have recognized that certain bulk metallic glasses having glass transition temperatures of at least 600 degrees Celsius may be most useful as coatings for gas turbine engine components, although lower temperature glasses may find application in cooler portions of an engine.

Zirconium based metallic glasses and some common nickel based metallic glasses have insufficient glass transition temperatures on the order of about 480 degrees Celsius. However, some specialized formulations of iron, nickel and cobalt based alloys have emerged with higher glass transition temperatures, such as:

TABLE 1

| | Glass Transition Temperature |
|---|---|
| | (T_{g}) or Recrystallization |
| Metallic Glass | Temperature (Tₓ) in ° C. |
| Fe, 0-0.5 Co, 1 Cu, 3 Nb, | 510 (Tₓ) |
| 22.5 Si + B | |
| 76-80 at % Fe, 20-24 at % Si + B | 535 (Tₓ) |
| Co₆₅Si₁₅B₁₄Fe₄Ni₂ | 540 (Tₓ) |
| Fe₇₀Ni₂B₂₄Nb₄ | 565 (T_{g}) |
| Co₄₃Fe₂₀Ta_{5.5}B_{31.5} | 637 (T_{g}) |

Some nickel based metal glasses which include refractory element content have been under recent development. Metallic glasses for use in the GTE component disclosed may include metallic glasses having at least 30% by weight of Group V elements relative to a total weight of the metallic glass, including such nickel or cobalt based alloys. The following examples may have application in many gas turbine environments.

TABLE 2

| | Glass Transition Temperature |
|---|---|
| | (T_{g}) or Recrystallization |
| Metallic Glass | Temperature (Tₓ) in ° C. |
| Ni₆₀Nb₄₀₋ₓSnₓ with 3 << x << 9 | 622 (T_{g}) |
| Ni₆₀Nb₃₀Ta₁₀ | 661 (T_{g}) |
| Ni₆₀Nb₂₀Ta₂₀ | 721 (Tₓ) |

In addition, the following Ni—Ta—V based metallic glasses may be used in the disclosed components: Ni₅₄Ta₄₀V₇; Ni₅₇Ta₃₇V₆; Ni₆₇Ta₂₆V₇. While the exact glass transition temperature data for these metallic glasses is not known, a materials scientist or chemist skilled in the art may expect these compositions to have glass transition temperatures in the appropriate range based on other metallic glasses having significant percentages of Group V elements.

The layer of metallic glass 14 of the GTE component 10 disclosed in FIG. 1 serves to protect the crystalline superalloy substrate 12 from the gas turbine engine environment. Thus, the constituent metals of candidate metallic glasses may have relatively low thermal conductivities so as to enhance the overall heat insulating nature of the coating. Table 3 lists the various thermal conductivities of some of the constituent elements of the exemplar metallic glasses.

TABLE 3

| | Thermal Conductivity | Melting Point |
|---|---|---|
| Element | (W/(mK) | in ° C. |
| Ni | 91 | 1453 |
| Ta | 57 | 2996 |
| V | 31 | 1890 |
| Nb | 54 | 2477 |
| Os | 88 | 3033 |

As shown, atomic constituents of the candidate metallic glasses may have lower thermal conductivities than, for example nickel, which has a thermal conductivity of 91 W/mK.

FIG. 2 shows a process for forming the GTE component 10 including depositing a powdered alloy material 18 and powdered flux material 20 onto a surface of a crystalline alloy material 12, melting the deposited powdered alloy material 18 and powdered flux material 20 by traversing a laser beam 28 across the powder in the direction of the arrow to form a melt pool 30 covered by a layer of liquid slag 24, and cooling the melt pool 30 at a rate sufficient to form a solidified layer of metallic glass 14 under a layer of solidified slag 26. The slag can then be removed 34 to reveal the layer of metallic glass 14 deposited onto the crystalline alloy substrate material 12 (the component 10 as shown in FIG. 1). Metallic glass of the order of 0.5 to 3 mm thick may be deposited in a single layer. Thicker deposits may be achieved in multiple layers. The melting may be accomplished in various embodiments by selective laser melting (“SLM”), selective laser sintering (“SLS”), rastered laser processing over preplaced or fed materials, or spark plasma sintering (“SPS”).

The slag 24/26 functions to shield both the melt pool 30 and the solidified (but still hot) layer of metallic glass 14 from the atmosphere in the region downstream of the energy beam 28. The liquid slag 24 floats to the surface to provide a physical barrier from the atmosphere, and the flux may be formulated to produce a shielding gas in some embodiments, thereby avoiding or minimizing the use of an inert cover gas.

Because there will be heat lost from the melt pool 30 into the substrate material 12, it may be expected that there could be some growth of the crystalline structure into the melt pool 30. This effect is minimized by the overall speed of the cooling, and by the removal of heat by means other than through the substrate 12, as described more fully below.

The powdered alloy material 18 is illustrated as a layer sandwiched between upper and lower layers of powdered flux material 20, however other arrangements may be utilized, such as the powdered alloy material 18 may be mixed with the powdered flux material 20, or only one layer of powdered flux 20 may be used, or the powdered alloy material may be combined with the powdered flux material 20 into composite particles.

As for the flux itself, United States Patent Application Publication No. US 2015/0027993 discloses flux compositions for use in the repair and/or joining of the most difficult to weld superalloy materials and other alloy materials. That publication is incorporated herein by reference as providing exemplar fluxes that are candidate fluxes for use in the deposition of metallic glasses onto a crystalline super alloy substrate.

One such group of fluxes has the following composition:
5 to 85 percent by weight of a metal oxide, a metal silicate, or both;
10 to 70 percent by weight of a metal fluoride; and
1 to 30 percent by weight of a metal carbonate;
all relative to a total weight of the flux composition, wherein:
the flux composition does not contain substantial amounts of iron; and
the flux composition does not contain substantial amounts of Li₂O, Na₂O, or K₂O.

Another such group of fluxes include at least one constituent selected from the group consisting of a metal oxide, a metal silicate and a metal fluoride; and at least two metal carbonates.

In order to form metallic glasses, the melt pool 30 must cool at a rate sufficient to form a glass. While an overlying slag 24/26 would be expected to slow the cooling rate of the underlying melt pool 30, the present inventors have found that it is possible to utilize a flux material 20 that enhances the glass forming process. This may be accomplished by any of (1) designing a flux that aids in the “confusion effect,” a phenomenon that allows a metal to remain in its amorphous form (i.e. as a metallic glass) rather than undergoing a true phase change to a crystalline solid metal, (2) using a thin layer of flux material to enhance rapid cooling by conduction of heat, (3) incorporating a cooling agent into the flux, and/or (4) using a flux that radiates heat, as described more fully below. Fluxes of high thermal emissivity at elevated temperature may be advantageous. For example, at about 1100° C., fluxes high in silica would have an emissivity of about 0.75, as compared to fluxes high in alumina or zirconia which have relatively lower emissivity of about 0.45.

One way for enhancing glass forming ability is for the flux to aid in the “confusion effect.” Glasses are amorphous materials which exhibit as solids, but are actually highly viscous liquids. The confusion effect is a term of art describing the phenomenon responsible for a material's ability to form a glass instead of a undergoing a true phase change from liquid to solid. Usually, this requires a rapid cooling rate. However, in certain cases, metallic glasses may be formed with even modest cooling rates. This occurs when there are different alloying elements of various atomic sizes such that they cannot arrange themselves in a crystallographic structure before they cool and are “locked” into place. An amorphous and glass-like structure results. To facilitate conditions ripe for forming amorphous glasses by the confusion effect, the powdered flux material 20 may include atoms having an atomic radius at least 10% smaller than the atomic radius of the metallic element present in the highest mole fraction of the powdered alloy material 18, or at least 10% larger than the metallic element present in the highest mole fraction of the powdered alloy material. Interaction of the flux with the melt pool 30 thereby contributes to the confusion effect.

The aforementioned United States Patent Application Publication No. US 2015/0027993 describes the use of a slag layer of at least 0.5 mm in thickness in order to slow the cooling of the underlying melt pool, thereby reducing residual stress in the deposited material. In the present invention, a quantity of powdered flux material may be used such that the resulting layer of slag is less than 0.5 mm thick, or from 0.3 mm to 0.4 mm thick in some embodiments, which is adequate to provide the beneficial shielding and cleaning functions, but which minimizes its thermal insulating effect.

In some embodiments, the flux may be enhanced with a cooling agent. One exemplar cooling agent may be a set of materials which participate in an endothermic process. This endothermic process may be, for example, an endothermic reaction such as an endothermic decomposition, or a heat absorptive phase change, or transition from a gas to plasma. If the endothermic process is a reaction, the cooling agent may be a set of reactants added to the powdered flux material 20 before or at the time of melting which combine to form products in an endothermic reaction. Because the reaction is endothermic, it will draw heat away from the hot melt pool 30, thereby speeding the cooling process. Fluxes comprised of carbonates, for example calcium carbonate (CaCO₃), would absorb heat and form oxides and gases, for example CaO, CO₂ and/or CO, in endothermic decomposition reactions, thereby both removing heat from the deposit and forming a shielding gas. Ammonium nitrite may also be included in the flux as it may absorb heat and decompose to yield nitrogen (somewhat shielding) and water vapor. Solid salts may also be included in the flux as they absorb heat upon melting during liquid slag formation. Also, to the extent that the laser interacts with gas molecules to form a plasma, such dissociation is endothermic. Processing in an atmosphere containing methane and water could also chill the deposit by the reaction CH₄+H₂O⇄CO+3H₂, because it is a reaction that takes place at relatively high temperatures (around 1100 C), which forms a gas (H₂—also good for shielding), and which uses nickel as a catalyst (which may be a constituent in the metallic glass). The release of H₂ in this reaction (or due to other reactions of flux materials) in the presence of iodine (I₂) would, at elevated temperatures, also absorb heat and produce hydrogen iodide (HI).

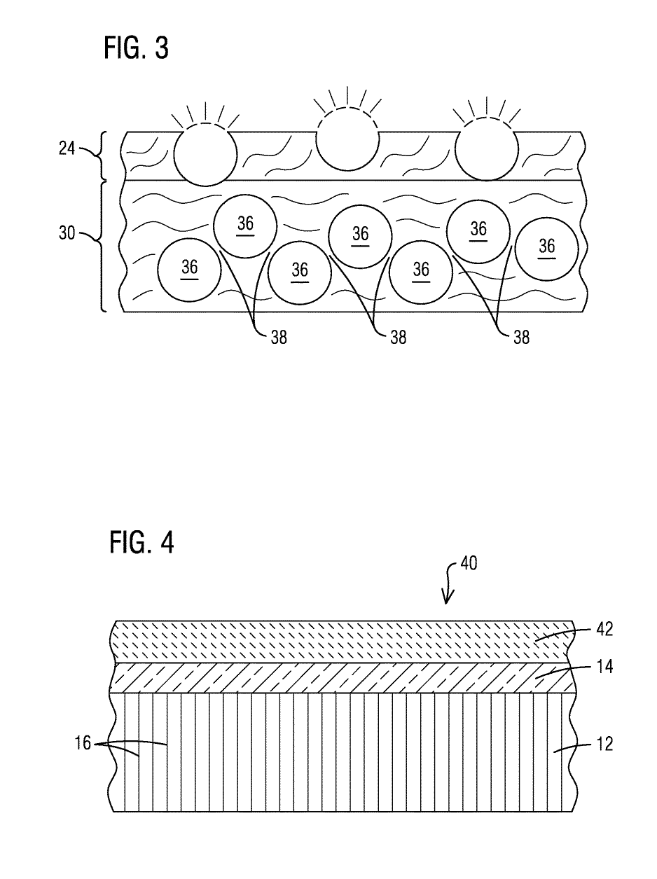

Another exemplar cooling agent may be a gas generating agent (“GGA”) included in the powdered flux material 18. This may be any substance or group of substances that rapidly form gases, such as substances that sublimate at or above room temperature, such as solid CO₂ (CO₂₍ₛ₎) or iodine (I₂₍ₛ₎), or a reactive material such as a carbonate which forms CO₂. In an embodiment involving solid CO₂ or iodine crystals, the solid is injected either in the layer of powdered alloy material, or the layer of powdered slag material, or both, either at the time of melting or just before. In the embodiment of FIG. 3, when the powdered alloy material and the powdered flux material are melted, the powdered flux material's gas generating agent forms gas bubbles 36 which rise through the melt pool 30. The bubbles create voids and narrow, thin channels 38 through the melt pool 30. In areas where these thin channels 38 are present, the melt pool 30 cools more quickly so as to form the layer of metallic glass 14. This is because heat is conducted away more rapidly from a thin material than a thick material. The resulting pores augment the thermal insulating properties and mechanical compliance of the resulting layer of metallic glass.

The flux may also have properties which allow it to radiate heat. Unlike the constituent metals of the metallic glass, the powdered flux material 20 may include metal elements having higher thermal conductivity, as higher thermal conductivity metals in the flux (and corresponding layer of liquid slag 24) will more rapidly radiate heat away from the melt pool 30. Also, as discussed above, fluxes of high silica (the metalloid oxide, SiO₂) content relative to alumina (Al₂O₃), or zirconia (ZrO₂) content may enhance heat radiation, for example at least two or three or four times the molar content of silica compared to alumina, or zirconia, or the combination of alumina and zirconia.

Flux mediated processes for the deposition of metallic glass offer several benefits including but not limited to the following: (1) the methods may take place at atmospheric pressure, thereby preventing volatilization and loss of essential elements; (2) the flux removes impurities which could impede glass formation by promoting crystalline formation; (3) introducing disorder to the melt pool due to the confusion effect and varying sizes of flux constituents versus metallic glass constituents, thereby enhancing amorphous glass formation; and (4) enhancing rapid cooling of the melt pool so as to enhance glass formation when the powdered alloy material is melted and subsequently cooled.

The inventors herein have recognized that the disclosed flux mediated deposition processes are thus far the only known methods for depositing metallic glass on a crystalline superalloy substrate, and that the resulting structure has both the insulating effects of the metallic glass layer as well as the mechanical properties and performance needed for components used in high temperature environments. High Velocity Oxy-Fuel processes (“HVOF”) and many of the thermal processes described in the aforementioned United States Patent Application Publication No. US 2014/0287149 A1 would offer inadequate control of cooling rate and physical management of the deposit needed to achieve high quality metallic glass deposition. HVOF can deposit amorphous material but only in splats (droplets flattened upon impact and solidification). Any amorphous material deposited in this fashion would have lamellae-like structure because it would consist of many thin, flat layers. These thin flat layers are prone to cracks and incomplete bonding between the splats. While this structure may aid in insulation, it can be problematic in terms of mechanical properties, durability, and performance. Also, because HVOF is an oxidizing process, it would introduce impurities which could initiate crystallization and result in a semi-amorphous layer of inferior properties or a layer with no amorphous glass at all. These shortcomings may explain why there has been no prior teaching of a GTE component having a protective layer consisting essentially of metallic glass.

Embodiments of the GTE component 10 do not require a bond coat atop (or under) the metallic glass, and may even replace the need for a bond coat (such as standard MCrAIY bond coats, known in the art) to adhere heat resistant ceramics to the GTE component. In high temperature applications, bond coats are used to aid in bonding ceramic to a superalloy substrate. A bond coat is used because its coefficient of thermal expansion is in between that of the substrate and the ceramic and it controls deleterious diffusion. This allows for reduced cracking of the ceramic caused by the expansion of the underlying metal, a problem that occurs if ceramic is laid directly atop a superalloy. Metallic glasses can be more ductile than superalloys and common bond coats, thereby accommodating the difference in expansion better than a bond coat and transferring lower thermal loads to the ceramic. This is because metallic glass 14 has an amorphous structure, which has more “give” within its microstructure for preventing cracking in ceramic overlays. The metallic glasses described herein may have coefficients of thermal expansion (CTE) in the range of 5 to 30×10⁻⁶/° C. With superalloy CTE of the order of 15×10⁻⁶/° C. and with TBC of much lower CTE, a metallic glass may be chosen of intermediate CTE to reduce the propensity for spallation. Further, the metallic glass may better insulate the underlying substrate thermally than bond coat, thereby minimizing the expansion of the metal.

Other embodiments of GTE components incorporating a layer of metallic glass are not excluded by way of this disclosure. For example, FIG. 4 shows a GTE component 40 having a ceramic material 42 disposed on top of the layer of metallic glass 14. Other embodiments may further include a layer of bond coat material adjacent (under or over or both) the layer of metallic glass 14.

While various embodiments of the present invention have been shown and described herein, it will be obvious that such embodiments are provided by way of example only. Numerous variations, changes and substitutions may be made without departing from the invention herein. For instance, the component disclosed is not limited to use as a gas turbine engine component. The component may be used wherever heat resistant materials are needed. Accordingly, it is intended that the invention be limited only by the spirit and scope of the appended claims.

The invention claimed is:

1. A method comprising:
depositing powdered alloy material and powdered flux material onto a surface of a crystalline alloy material;
melting the deposited powdered alloy material and powdered flux material to form a melt pool covered by a layer of liquid slag;
cooling the melt pool at a rate sufficient to form a solidified layer of metallic glass under a layer of solidified slag; and
removing the solidified slag to reveal the layer of metallic glass deposited onto the crystalline alloy material.

2. The method according to claim 1, wherein the crystalline alloy material is a superalloy and the metallic glass has a glass transition temperature of at least 600° C.

3. The method according to claim 1, wherein the metallic glass comprises at least 30% by weight of Group V elements.

4. The method according to claim 1, wherein the powdered flux material comprises atoms having respective atomic radii at least 10% smaller than, or at least 10% larger than, an atomic radius of a metallic element present in a highest mole fraction of the powdered alloy material.

5. The method according to claim 1, wherein the melting and cooling steps are performed in an atmosphere containing methane and water.

6. The method according to claim 1, further comprising cooling the melt pool in a manner such that grains of the crystalline alloy material grow into the cooling melt pool as the solidified layer of metallic glass is forming.

7. The method according to claim 1, further comprising depositing a cooling agent with the powdered alloy material and powdered flux material onto the surface of the crystalline alloy material, the cooling agent effective to remove heat from the melt pool during the cooling step.

8. The method according to claim 7, wherein the cooling agent comprises a material which participates in an endothermic reaction during the cooling step.

9. The method according to claim 7, wherein the cooling agent comprises a gas generating agent.

10. The method according to claim 1, further comprising depositing a layer of a ceramic insulating material over the layer of metallic glass.

11. A gas turbine engine component formed in part by the process of claim 1.

12. The gas turbine engine component of claim 11, further comprising a layer of ceramic insulating material deposited over the layer of metallic glass.

13. A flux useful during the deposition of a layer of alloy material onto a crystalline substrate by the melting and resolidification of a layer of powdered alloy material in the presence of the flux, the flux characterized by a composition effective to facilitate solidification of the layer of alloy material as a layer of metallic glass.

14. The flux of claim 13, wherein the flux composition comprises a material that participates in an endothermic reaction during the resolidification.

15. The flux of claim 13, wherein the flux composition comprises a gas generating agent.

16. The flux of claim 13, wherein the flux composition comprises iodine.

17. The flux of claim 13, wherein the flux composition comprises SiO₂, but does not contain substantial amounts of ZrO₂ or Al₂O₃.

18. The flux of claim 13, wherein the flux composition comprises at least one of the group of ammonium nitrite and solid salts.

19. The flux of claim 13, wherein the flux composition comprises:
5 to 85 percent by weight of a metal oxide, a metal silicate, or both;
10 to 70 percent by weight of a metal fluoride; SiO₂, or both; and
1 to 30 percent by weight of a metal carbonate,
all relative to a total weight of the composition, wherein:
the flux composition does not contain substantial amounts of iron, ZrO₂, Al₂O₃, Li₂O, Na₂O, or K₂O.

20. The flux of claim 13, wherein the flux composition comprises a substance that sublimates at or above room temperature.
